(19) United States
(12) Patent Application Publication
(10) Pub. No.: US 2007/0018843 A1
(43) Pub. Date: Jan. 25, 2007

(54) Anti-theft system and apparatus and method for selectively disabling/enabling electrical apparatus

(76) Inventor: Devon David Cullum, Meridian, ID (US)

Correspondence Address: TRASK BRITT, P.O. BOX 2550, SALT LAKE CITY, UT, 84110, US

(21) Appl. No.: 11/526,510

(22) Filed: Sep. 25, 2006

Related U.S. Application Data
(63) Continuation of application No. 09/296,676, filed on Apr. 22, 1999.

(51) Int. Cl. G08B 5/22

(52) U.S. Cl. 340/825.49

(57) ABSTRACT

An anti-theft apparatus is mounted within the casing of an electronic apparatus and coupled to the power supply of the electronic apparatus. The system includes tracking structure enabling the device to be located in the event of theft. Upon receipt of an interrogator signal, the system disables the apparatus, rendering it useless to the thief or a subsequent purchaser. The power supply can be reactivated by entry of appropriate information relating to the device and/or owner.

### CROSS-REFERENCE TO RELATED APPLICATION

This application is a continuation of application Ser. No. 09/296,676, filed Apr. 22, 1999, pending.

### BACKGROUND OF THE INVENTION

The present invention relates to a technique for discouraging and preventing theft of electronic devices or other property. More particularly, the present invention relates to a system for locating stolen properties and selectively disabling certain properties to render the property useless to a thief.

The number of consumer electronic devices has increased greatly in recent years. For example, most American households today include at least one computer, compact disk player, video cassette recorder, television, stereo, etc. Many of these consumer electronic devices are designed and manufactured for portability. Such portable consumer electronic devices include personal stereos, camcorders, battery operated televisions, and the like.

Recent years have also seen a greater awareness of crime. The proliferation of consumer electronic devices has increased the opportunities for thieves to steal valuable property. Moreover, because many consumer electronic devices are now designed to be small and portable, it becomes increasingly likely that a consumer will inadvertently leave an electronic device in a public place where it can be picked up by any passerby. Because these devices may be small, they are easily concealed and carried by a thief. Of course, many of these lost or stolen devices will never be recovered by the rightful owner.

A number of anti-theft measures have been developed in an effort to protect personal property and goods. For example, anti-theft measures such as keys, alarms, and video surveillance for limiting use or access to personal property are known. In addition, affixing anti-theft identification serial numbers to the goods assists in the identification of stolen goods once they are recovered.

Experienced thieves, however, are usually capable of bypassing most anti-theft measures. Keys can be remade; locks may be picked; surveillance systems may be disabled or avoided; identification numbers may be obliterated or modified. Once these anti-theft measures are bypassed, the stolen equipment still functions properly. Moreover, the stolen equipment is usually difficult to trace and recover. “Hot” equipment may still function in the hands of an unauthorized holder and therefore may still be useful to thieves or downstream transferees. Accordingly, although these prior techniques are useful, they generally have not been completely satisfactory.

It is desired to provide an effective system for preventing or at least discouraging theft of personal items such as consumer electronic devices. Additionally, it is useful to provide a simple and effective, low cost technique for locating stolen or lost goods for return to their rightful owners. Locating stolen goods also provides law enforcement agencies with a tool in combating organized crime rings. The present invention provides these advantages.

### BRIEF SUMMARY OF THE INVENTION

The apparatus and method according to the present invention preferably utilize an anti-theft device to selectively disable stolen property. The device may also track the location of the stolen apparatus. In this manner, when an item incorporating the anti-theft device is reported stolen, an interrogator uses satellite link or other communication channel to send a disable signal to the apparatus. Once the stolen product receives the disable signal from the interrogator, the anti-theft device will be uniquely identified and instructed appropriately to control the shut-off unit to disable the stolen equipment.

In preferred embodiments, the invention includes an anti-theft device operable with an electronic apparatus. The device includes a remote intelligent communications (RIC) unit that receives a shut-off signal from an interrogator and a shut-off unit comprised of components of the RIC unit and coupled with a power source of the electronic apparatus. When disabled, the shut-off unit may prevent a flow of electricity via the power source or otherwise shut down the device.

As noted above, the RIC unit includes structure that enables tracking of the electronic apparatus. The device may further include a deactivate assembly communicating with the shut off unit. The deactivate assembly preferably includes a controller which communicates with a memory and an input device. Data relating to the electronic apparatus is stored in the memory. The controller preferably maintains the shut-off unit in the shut-off state until predetermined data corresponding to the electronic apparatus data is entered via the input device. Alternatively, the anti-theft device may include a coded reset device, wherein the shut-off unit remains in the shut-off state until a predetermined code is input to the reset device. The anti-theft device may further include a message activating unit communicating with the RIC unit that activates a message in response to the shut-off signal.

In accordance with another aspect of the invention, a method is provided for operating an anti-theft device in cooperation with an electronic apparatus. The method may include the steps of tracking the electronic apparatus with the RIC unit, and preventing with the shut-off unit a flow of electricity via the power source in response to the shut-off signal. The method may further include the step of maintaining the shut-off unit in a shut-off state until predetermined data corresponding to the electronic apparatus data is entered via the input device. Alternatively, the method may include the step of maintaining the shut-off unit in a shut-off state until a predetermined code is input to the reset device. The method may still further include the step of activating a message in accordance with the shut-off signal.

### BRIEF DESCRIPTION OF THE SEVERAL VIEWS OF THE DRAWINGS

The various characteristics, features and advantages of the present invention will be apparent to the skilled practitioner from a reading of the following detailed description when read in view of the accompanying drawings, in which:

FIG. 1A is a schematic illustration used to generally describe the operation of one implementation of the present invention;

FIG. 1B is a functional block diagram illustrating an interrogator system useful in a system such as that shown in FIG. 1A;

FIG. 2 is a functional block diagram illustrating one implementation of a consumer electronic device constructed in accordance with the present invention and useful in a system such as is described in connection with FIG. 1;

FIG. 3A is a schematic diagram of a simple power blocking disable circuit that may be used in connection with the implementation of FIG. 2;

FIG. 3B is a schematic diagram of an alternative power blocking disable circuit that may be used in connection with the implementation of FIG. 2;

FIG. 4 is a flow chart illustrating an example set-up procedure that may be used in connection with the present invention; and

FIG. 5 is a flow chart illustrating an example tracking/disable procedure that may be used in connection with the present invention.

### DETAILED DESCRIPTION OF THE INVENTION

In the following detailed description, the invention will be described with respect to its application to an electronic device such as a portable stereo. Those of ordinary skill in the art, however, will appreciate that there are numerous applications of this subject matter according to the present invention, and the invention is not meant to be limited to the apparatus or type of apparatus that is specifically illustrated and described.

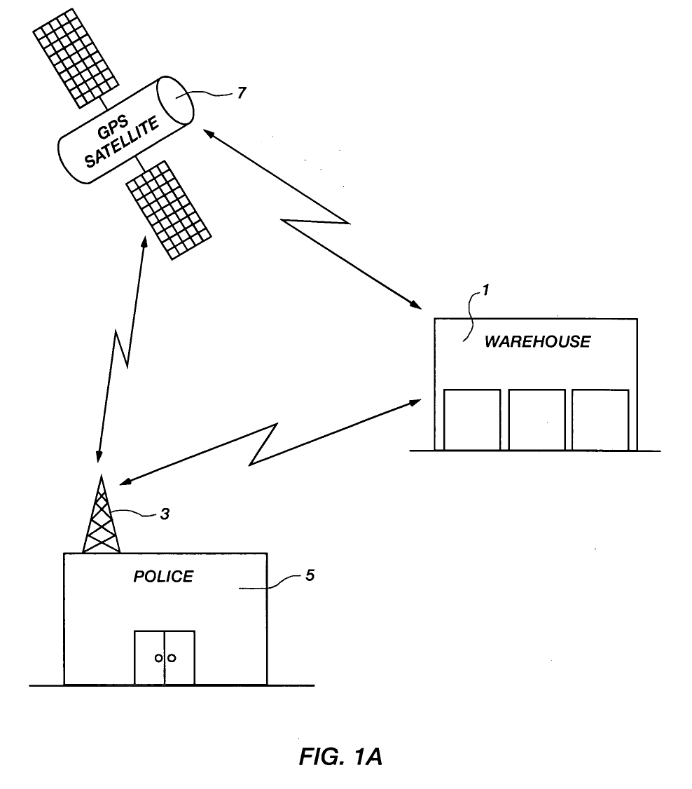

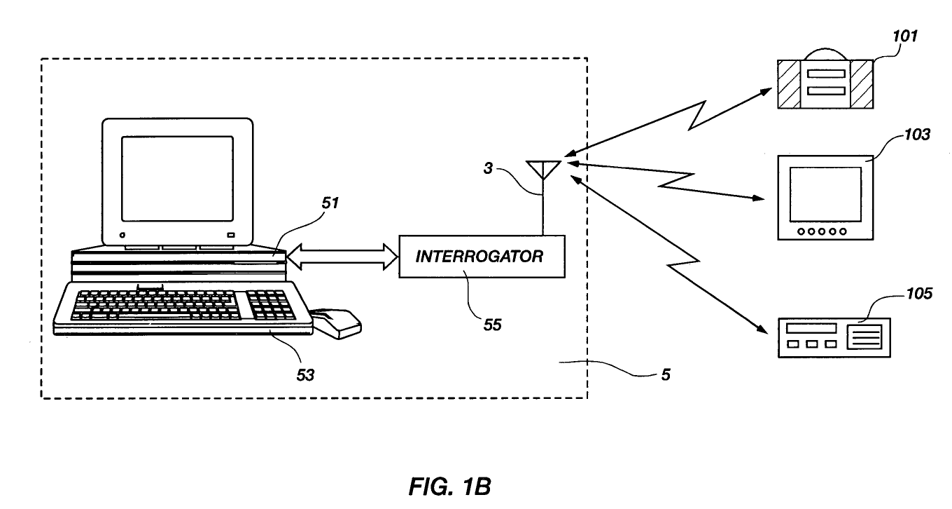

In accordance with one aspect of the present invention, a lost or stolen article may be tracked and/or selectively disabled to discourage theft by rendering the article useless to an unauthorized individual. Referring to FIG. 1A, a warehouse 1 is used in a “fence” operation to store stolen goods in a location hidden from law enforcement officials. However, as will be described below in greater detail, stolen goods that incorporate an anti-theft apparatus in accordance with the present invention allow law enforcement officials to track the location of the missing goods and selectively disable those goods.

In particular, a report of stolen goods causes a tracking/disable signal to be broadcast over the air waves by an antenna 3 at a police station 5. The signal preferably includes the serial number of the goods or some other unique identifier so the goods can determine whether the signal is intended for it. In response to receipt of the tracking/disable signal, the goods can provide a return broadcast acknowledging receipt of the tracking/disable signal and preferably including location coordinates derived from a global positioning system (GPS) satellite 7.

Furthermore, circuitry within the stolen goods can generate an internal signal which causes the device to shut down or otherwise fail to operate properly. Additionally, the disable signal may cause the goods to issue audible signals such as an alarm or an appropriate audio recording.

It should be noted that although the illustrative system described in FIG. 1A utilizes a radio broadcast of the tracking and disable signals, one of ordinary skill in the art will recognize that other options are available. For example, the effective range of the tracking/disable signal may be increased regionally or nationally by communicating through a cellular telephone network. Similarly, global range could be obtained through satellite communications. Also, although a police station is illustrated as the origin of the tracking/disable signal, any other appropriate origin is possible. For example, signals may originate from a private security firm, insurance providers, electronic retail stores or headquarters, or the like.

FIG. 1B illustrates in greater detail an interrogator system that may be used in connection with the system of FIG. 1A. Briefly, equipment located at the police station 5 or other appropriate location is identified within the dashed lines and includes a host computer 51 having an associated input device (or devices) such as a keyboard 53, a mouse, etc. Additionally, an interrogator 55 coupled with antenna 3 is provided to broadcast tracking/disable signals upon command to lost or stolen articles such as a personal stereo or “boom box” 101, a television 103, a video cassette recorder 105 and the like. These items, of course, are merely examples.

In operation, upon receiving a stolen property report, police personnel would obtain information concerning the property including unique identifying information such as a serial number. Other information specific to the property, such as purchase date and location, perhaps the name of the rightful owner, etc. could be entered as well if such information was previously stored in memory of the stolen property. This property information would then be entered into the host computer 51 which, in turn, would direct the interrogator 55 to broadcast an appropriate tracking/disable signal over antenna 3. Upon receipt of the tracking/disable signal, a processor in the stolen property verifies from information contained in the signal that it is the intended recipient and responds accordingly. If tracking information is returned from the stolen property to the interrogator 55, it may be processed by the host computer 51 to alert police personnel of the location of the goods. If desired, the host computer could be associated with a dispatch system to promptly dispatch an officer to the location.

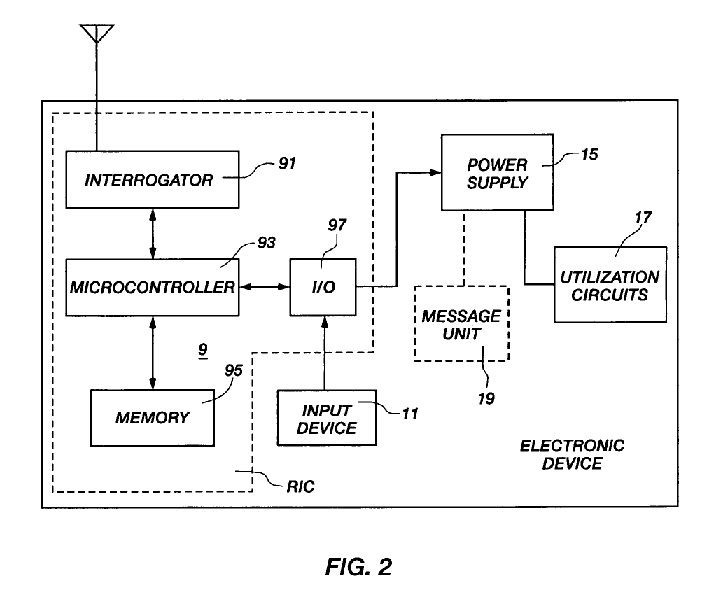

Turning now to FIG. 2, an anti-theft device according to a preferred embodiment of the present invention may include a remote intelligent communication (RIC) unit 9 and an input device 11 contained within a conventional electronic device 13, such as a portable stereo. Briefly, the RIC 9 may be an integrated circuit with built in radio, processor, and memory circuits. The RIC unit 9 preferably includes a transceiver 91, a microcontroller 93, a memory device 95, and a digital serial I/O port 97. The RIC unit 9 may be provided on a single CMOS chip and may include additional features such as a clock recovery system and a spread spectrum processor. The transceiver 91 may include, for example, a modulated back scatter transmitter. Of course, separate receivers and transmitters could be provided. An appropriate RIC unit is commercially available from the Micron Communications, Inc. of Idaho through its MicroStamp™ product line. Accordingly, the details of the structure need not be further described. Additionally, further details of appropriate enabling circuitry for implementing the transceiver, processor and memory portions of FIG. 2 are disclosed in co-pending, commonly owned U.S. application Ser. No. 08/705,043 filed Aug. 29, 1996 (Docket Number 96-0327US), which is hereby incorporated by reference in its entirety.

The input device may be, for example, a keypad or other input device provided on the electronic device itself. Alternatively, the input device may be an input terminal or connector which permits the device to receive input signals from another device such as a personal computer. Utilizing an input connector as the input device may be preferable in most consumer electronic devices to help minimize the size of the product and to reduce manufacturing costs.

The RIC unit 9 is preferably mounted within the casing of the electronic device 13. A disable or shut-off unit including the RIC microcontroller 93 and the RIC I/O port 97 is coupled with a power supply 15 of the electronic device 13. In some electronic devices, the power source may include both A/C and D/C supplies, in which case the shut-off unit preferably would be coupled with both. Shut-off may be implemented by providing a selectively activated power blocker board between the power source (e.g., batteries or electrical plug) and the device circuits which utilize the power. Alternatively, power may be diverted from the normal utilization circuits 17 of the device (e.g., radio receiver and amplifier) to a message unit 19.

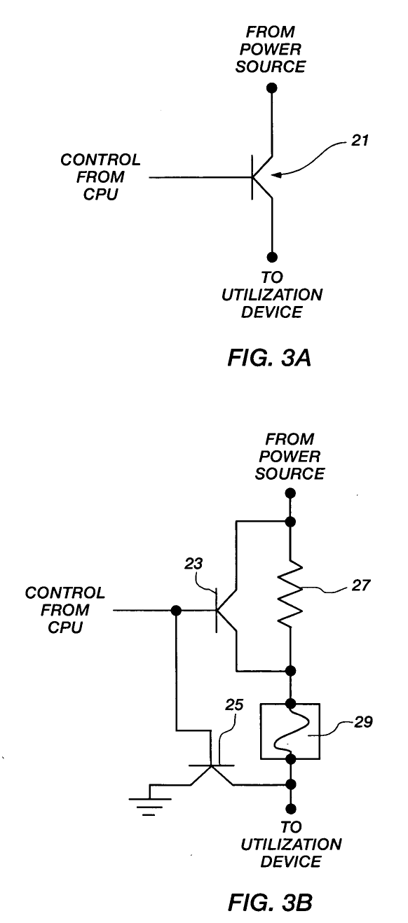

A simple technique for disabling the source of power is illustrated in FIG. 3A. Briefly, a transistor 21 is placed in line between the power source and the circuitry of the utilization device, such as the electronic device of FIG. 2. The gate of transistor 21 is controlled by a gate signal from the RIC microcontroller 93 by way of input/output circuit 97. In normal operation, the gate signal controls the transistor 21 to allow power to pass from the power source to the utilization device. However, when a disable signal is received by the RIC unit 9, the microcontroller changes the state of the gate signal to turn off transistor 21 and thereby block power flow to the utilization device.

In a preferred implementation, once the device is disabled, the microcontroller is programmed to maintain the transistor 21 in an OFF state until the device is reset by an authorized repair center or the rightful owner of the goods. For example, the microcontroller 93 can maintain the transistor 21 in the OFF state until an appropriate security code or other information that is available to the rightful owner (such as purchase date, location, etc.) is entered by way of input device 11. The microcontroller compares the input date to stored data to verify the information is being input by authorized personnel. If desired, provisions could also be made to reset the system remotely by transmission of a reset signal that is received by the RIC unit 9 through transceiver 91. Any such remote reset signal also should include security information such as a PIN number. Security in remote resetting can be increased by using digital transmissions and/or by encrypting the information contained in the broadcast reset signal.

An alternative power blocking circuit is shown in FIG. 3B, and includes transistors 23 and 25, resistor 27, and a fuse or fusible link 29. In normal operation, transistors 23 and 25 are in the OFF state and power flows through resistor 27 and fuse 29 to the utilization device. The resistor is sized to ensure normal circuit flow does not blow the fuse 29. However, upon receipt of a disable signal, the microcontroller 93 produces a gate control signal to transistors 23 and 25 to place those transistors in a conductive ON state. As a result, current flows through a low resistance path from the power source, through transistor 23 (bypassing resistor 27), fuse 29 and transistor 25 to ground. The fuse is signal so that the magnitude of current causes it to blow, thereby preventing power from reaching the utilization device.

To reset a device having the blocking circuit of FIG. 3B, it is necessary to replace the fuse 29 as well as reset the microcontroller 93 as discussed above. If a thief merely replaces the fuse, the microcontroller 93 will likewise blow the replacement fuse until it is reset by receipt of appropriate security information.

In a preferred implementation, the power blocking circuit of FIG. 3A or 3B is included within a packaged integrated circuit chip along with other circuitry required by the utilization device. In this way, a thief would not be able to simply bypass the power blocking circuit. If a fusible link is used, it may be necessary to replace the packaged integrated circuit chip once the property is recovered. Although this could be done relatively economically by an authorized dealer (once the microcontroller 93 has been reset), it may be unlikely that a thief would find the associated effort and expense worthwhile.

The power blocking circuits of FIGS. 3A and 3B operate to create an open circuit condition between the power source and the utilization circuitry of the electronic device. Other arrangements can also be implemented to prevent operation of the device. Additionally, if desired, the disable signal may cause a power blocking circuit to switch power from the electronic device to a message unit or alarm that produces audible warnings concerning the stolen property.

It should be appreciated that the power blocking circuits of FIGS. 3A and 3B are merely exemplary, and that many other appropriate arrangements may be readily implemented by one of ordinary skill. Additional safeguards such as an interlock provision which automatically blocks power if the power blocking circuit is bypassed or if the RIC unit 9 is disconnected from the power blocking circuit may also be provided. Such an arrangement is within the skill in the art.

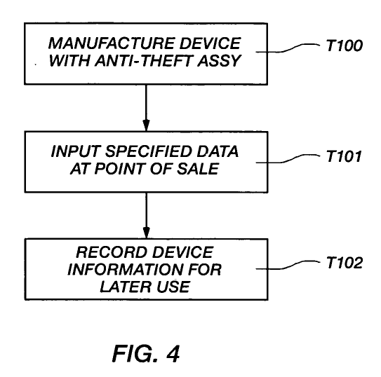

FIG. 4 is a flow diagram illustrating steps that may be taken to initially set up the anti-theft features of the device. Specifically, in a preferred arrangement, the anti-theft assembly may be incorporated into the electronic device by the manufacturer (T100). At the retail level, for example, data relating to the electronic apparatus may be input via the input device 11 (T101) and is stored in the memory 95 via the I/O port 97. The input data should include at least a unique product identifier such as a serial number. Additional information such as authorized user information, purchase information, reset authorization security codes and the like may also be entered at this time.

The information entered into the device may then be recorded for later access by the user when needed. For example, the user may obtain a print out of the serial number and other pertinent information for safekeeping in a secure location. The information may also be recorded in a secure database maintained, for example, by a local security service organization. A database may include a consolidated record of devices owned by a particular individual. Thus, separate records may be stored in the database for each item owned by an individual that includes an anti-theft device in accordance with the present invention.

In operation, the RIC unit 9 is typically idle, resting in a low-current sleep mode. An internal programmable timer periodically causes the RIC unit to wake up. The microcontroller 93 then activates transceiver 91 to determine whether there is a properly modulated RF signal present. If not, the RIC unit 9 returns to the sleep mode.

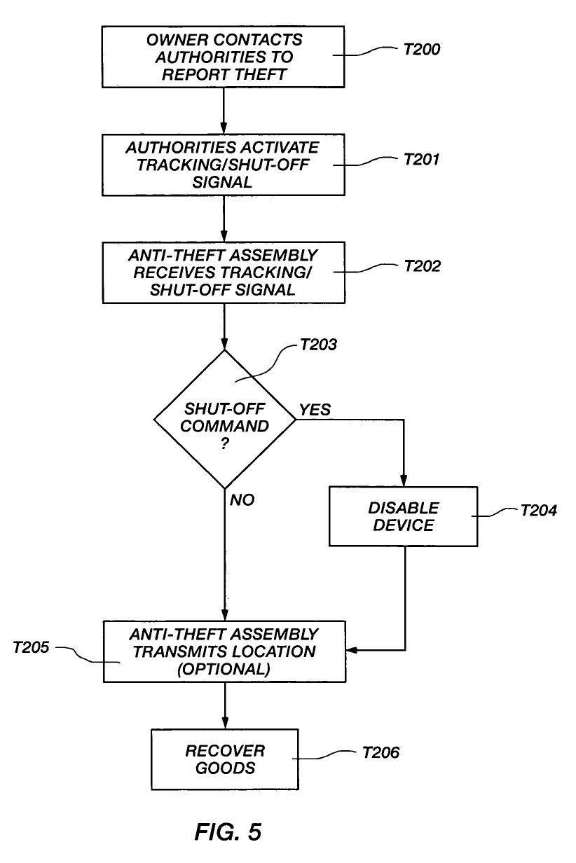

Turning now to FIG. 5., when the electronic device 13 has been stolen, the purchaser contacts the police or a security service organization (T200), and the tracking/shut-off signal is activated (T201). When the RIC unit 9 wakes up, if a valid signal is present, the RIC unit 9 processes the received command (T202). The microcontroller evaluates the received signal to determine whether it includes the unique identifier for the item in which it is installed. If so, the received tracking/disable signal is evaluated to determine whether a shut-off command is included (T203). A shut-off command causes the microcontroller 93 to disable the device (T204) as discussed above.

The microcontroller may also activate a message unit or alarm by, for example, diverting power from the utilization device. In this case, a pre-recorded audio message may be played to inform the thief that the device has been disabled. Similarly, an alarm may be issued to draw attention to the thief. This audio message or alarm may be repeated periodically.

The anti-theft device may operate in either a passive mode or an active mode. In the passive mode, the device may be disabled, but no acknowledgment is transmitted back to the authorities. In that case, the RIC transmitter may be omitted to reduce the size and expense of the device. However, in the active mode, the RIC unit 9 transmits an acknowledgment that the tracking/disable signal has been received. Location information derived, for example, from a global positioning system may also be transmitted to alert authorities of the location of the device (T205) so that the device may be recovered (T206). Periodic retransmission of location data can be used to guard against movement of the goods.

Once the device is recovered, it can be brought to a designated repair shop or the like to be reactivated. The designated repair shop enters predetermined data corresponding to the electronic apparatus data via the input device 11 through the digital serial I/O port 97. The microcontroller 93 compares the input information with the information stored in the memory unit 95. If the input information is accurate, the microcontroller 95 reconnects the device power supply through I/O port 97. If necessary, any blown fuses could be replaced. The device can then be returned to the purchaser. As an alternative to storing data relating to the electronic apparatus, the memory unit 95 could instead store a security code such that the shut-off unit remains in the shut-off state until the security code is entered.

As noted above, the tracking signal need not include a shut-off command. This may be used, for example, to help locate missing goods without disabling the goods. Such an arrangement would enable the device to be located by transmitted location information or by auditory signal.

By virtue of the structure and method according to the present invention, a stolen product can be deactivated in the hands of a thief, rendering the apparatus useless for the thief or a subsequent purchaser. The device thus serves as an effective theft deterrent.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of operating an anti-theft device, comprising:
inputting into a memory in the anti-theft device at a point of sale a unique identifier of a specific one of an electronic apparatus having normal utilization services therein; and
entering a shut-off state and disabling operative power via a shut-off signal to the normal utilization circuits in response to receipt of a shut-off command designating the unique identifier stored in the memory.

2. A method of claim 1, the method further comprising maintaining the shut-off state until predetermined data corresponding to the unique identifier is entered via an input device coupled to the electronic apparatus.

3. The method of claim 1, wherein the anti-theft device further includes a message activating unit, the method further comprising activating a message in accordance with the shut-off signal.

4. The method of claim 1, wherein the shut-off unit further includes a fusible link.

5. An anti-theft device for shutting off an operable electronic apparatus, comprising:
a memory configured to receive and store therein a unique identifier of a specific one of the electronic apparatus;
means for inputting the unique identifier into the memory at a point of sale; and
a control circuit configured to block power to normal-utilization circuits in the electronic apparatus upon receipt of a shut-off signal designating the unique identifier of the electronic apparatus.

6. The anti-theft device of claim 5, further comprising a transmitter to provide tracking data for locating the electronic apparatus.

7. The anti-theft device of claim 6, wherein the tracking data comprises location coordinates derived from a global positioning system satellite.

8. The anti-theft device of claim 5, further comprising a transmitter to acknowledge receipt of the shut-off signal.

9. The anti-theft device of claim 5, further configured to maintain the block of power to the normal-utilization circuits until disabling of the block of power to the electronic apparatus is authenticated.

10. The anti-theft device of claim 5, wherein the unique identifier stored data comprises purchase data.

11. The anti-theft device of claim 5, wherein the unique identifier stored data comprises purchaser data.
